(19) United States
(12) Patent Application Publication
(10) Pub. No.: US 2014/0164964 A1
(43) Pub. Date: Jun. 12, 2014

(54) CUSTOMIZABLE DATA VISUALIZATION

(71) Applicants: Finlay Cannon, Vancouver (CA); Scott Cameron, Vancouver (CA); Julian Gosper, Vancouver (CA)

(72) Inventors: Finlay Cannon, Vancouver (CA); Scott Cameron, Vancouver (CA); Julian Gosper, Vancouver (CA)

(21) Appl. No.: 13/711,983

(22) Filed: Dec. 12, 2012

(51) Int. Cl. G06F 3/0484

(52) U.S. Cl. CPC G06F 3/04842
USPC 715/765

(57) ABSTRACT

Various embodiments of systems and methods for generating customizable data visualization are described herein. Several data point generation options may be displayed to visualize a to-be-visualized data element. Data point generation options may then be selected from the displayed data point generation options to render a visualization corresponding to the to-be-visualized data element. Based on the selected data point generation options, the visualization, including data points corresponding to the data values of the to-be-visualized data element, may be rendered.

### FIELD

Embodiments generally relate to computer systems, and more particularly to methods and systems for generating customizable data visualization.

### BACKGROUND

Data visualization and data driven reporting are key to several business. Usually, these data visualizations or reports may be used by many users for different purposes. At present, different pre-defined visualization templates, such as, line-graph chart, bar chart, etc. are provided to a user for visualizing the data. These pre-defined visualization templates have pre-defined visualization features, which limit the possible visualization options provided to the end user.

### BRIEF DESCRIPTION OF THE DRAWINGS

The claims set forth the embodiments with particularity. The embodiments are illustrated by way of example and not by way of limitation in the figures of the accompanying drawings in which like references indicate similar elements. The embodiments, together with its advantages, may be best understood from the following detailed description taken in conjunction with the accompanying drawings.

FIG. 1 is a flow diagram illustrating a method for rendering visualization, according to an embodiment.

FIGS. 2A-2B is a detailed flow diagram illustrating a method for rendering visualization, according to an embodiment.

FIG. 3 is a flow diagram illustrating a method to render a visualization based on visualization template, according to an embodiment.

FIG. 4 is an exemplary block diagram illustrating a web browser application displaying different data elements for selecting a row axis data element, according to an embodiment.

FIG. 5 is an exemplary block diagram illustrating the web browser application of FIG. 4 displaying a rendered row axis, according to an embodiment.

FIG. 6 is a block diagram illustrating the web browser application of FIG. 4 displaying different data elements for selecting a column axis data element, according to an embodiment

FIG. 7 is an exemplary block diagram illustrating the web browser application of FIG. 4 displaying a rendered column axis, according to an embodiment

FIG. 8 is a block diagram illustrating the web browser application of FIG. 4 displaying different data elements for selecting a to-be-visualized data element, according to an embodiment

FIG. 9 is a block diagram illustrating the web browser application of FIG. 4 displaying a visualization corresponding to the data values of the selected to-be-visualized data element, according to an embodiment

FIG. 10 is a block diagram illustrating the web browser application of FIG. 4 displaying a re-rendered visualization based on a selected data point generation option, according to an embodiment

FIG.11 is a block diagram illustrating a computing environment in which the techniques described for dynamically generating customizable data visualization can be implemented, according to an embodiment.

### DETAILED DESCRIPTION

Embodiments of techniques for generating customizable data visualization are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

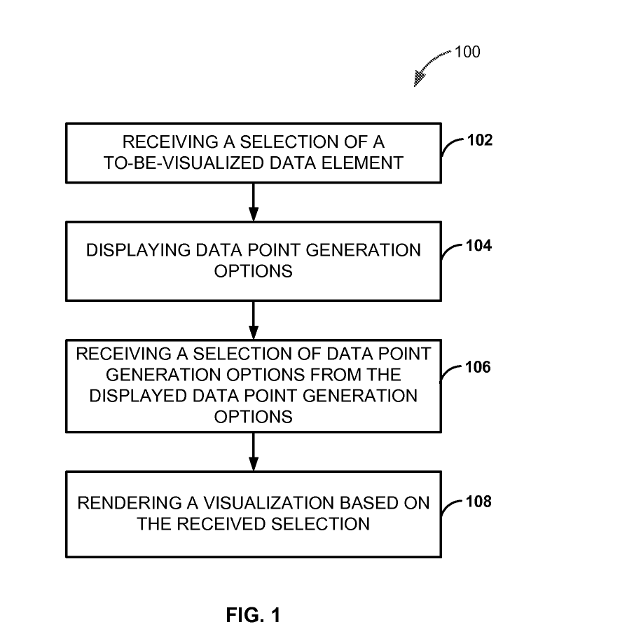

FIG. 1 is a flow diagram illustrating a method 100 for rendering visualization, according to an embodiment. Visualization is a visual representation of any information or data. For example, the visualization may be a chart, such as, a bar chart, a pie chart, or a line chart, a graph, a diagram, or any other visual representation of data. In one embodiment, the visualization may be a visual representation of a data element. A data element is a unit of information having a unique meaning and distinct units or data values. For example, country specific sales information of a product may include a “COUNTRY” data element and a “SALES VALUE” data element. The “COUNTRY” and “SALES VALUE” data element may have corresponding data values “CANADA, US, AUSTRALIA” and “30000$, 40000$, 50000$”, respectively. In one embodiment, visualization of a data element may include visualization of the data values corresponding to the data element.

Initially at block 102, a selection may be received for a to-be-visualized data element. The selection of the to-be-visualized data element may be received by a web browser application, displaying several data elements. A web browser application is a software application for retrieving, presenting and traversing information resources on the World Wide Web. In some embodiments the application and its server are behind a firewall or otherwise separated from the World Wide Web but are otherwise the same. The server can include a library to share the burden of preforming operations with application. In one embodiment, the web browser application may retrieve several data elements from a data source, for example, a database. The web browser may then display the retrieved data elements to a user. The user may then select a to-be-visualized data element, from the displayed data elements. The to-be-visualized data element may be a data element for which the visualization is to be rendered. The visualization may be a visual representation of the data values corresponding to the to-be-visualized data element. In the above example, the user may select the “SALES VALUE” data element as the to-be-visualized data element.

Next at block 104, the web browser application may display several data point generation options to render visualization for the to-be-visualized data element. In one embodiment, rendering the visualization may include rendering several data points representing data values of the to-be-visualized data element. A data point is a discrete unit of information in the visualization representing a data value of the to-be-visualized data element. The data point generation options may provide different options for generating the data points in the visualization. In the above example, the web browser application may display several data point “visualization type” options, including a “dot” option, a “bar” option, and a “tile” option, to select a visualization object for rendering data points corresponding to the three data values of the “Sales” data element. The data point generation options may also include several “color” attribute options, including a “gray scale” option and a “RGB” option, for selecting a color of the data points.

Next at block 106, data point generation options may be selected from the data point generation options displayed at block 104. The data point generation options may be selected to render data points corresponding to the data values of the to-be-visualized data element. In the above example, the user may select a “dot” option from the different data point “visualization type” options and an “RGB” option from the different data point “color” attribute options to render the data points corresponding to the three data vales of “Sales” data element.

Finally at block 108, visualization may be rendered based on the data point generation option selection received at block 106. Rendering is the process of generating a visualization based on an input data. In one embodiment, rendering the visualization may include rendering the data points corresponding to the data values of the to-be-visualized data element, based on the data point generation options selected at block 106. The web browser application may display the rendered visualization. In the above example, three “dot” data points may be rendered corresponding to the three data values of the “Sales” data element. The three “dot” data points may be colored red, green, or blue colors, based on the selected “RGB” option.

The different data point generation options may provide a user the flexibility to select different aspects of the visualization. The user may also have the flexibility to modify any feature of a rendered visualization based on a data point generation option selection. In the above example, the user may change the color of the rendered three data points from a RGB color scheme to a “grey scale by selecting the “grey scale” option for the “data point color” parameter. The three data points may then be re-rendered with a grey color.

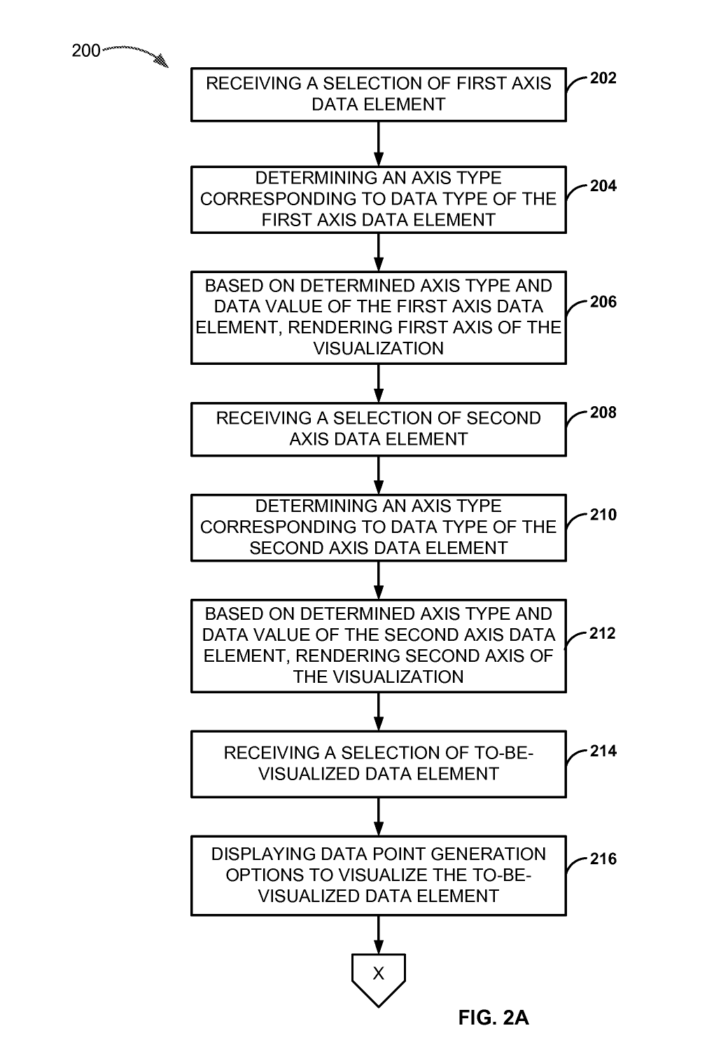

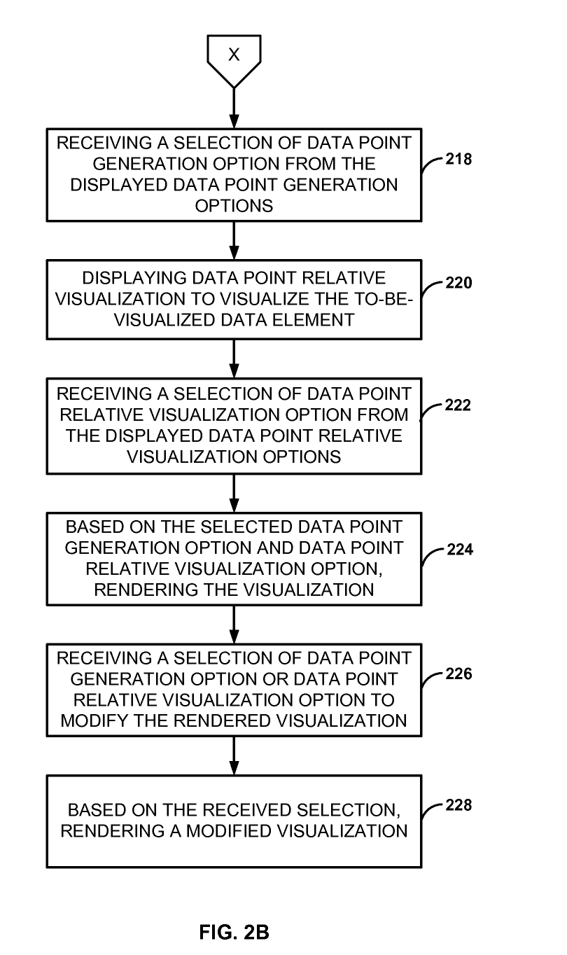

FIGS. 2A-2B is a detailed flow diagram illustrating a method 200 for rendering visualization, according to an embodiment. In one embodiment, a visualization generator may render the visualization corresponding to the to-be-visualized data element. A visualization generator may include different data point generation options, which may be used for rendering the visualization. The visualization generator may also include a renderer to render the visualization based on the data point generation options. In one embodiment, the visualization generator is a JavaScript™ API, which may be loaded to the web browser application displaying the data point generation options and the rendered visualization.

Initially at block 202 a selection of a first axis data element may be received by the web browser application. The first axis data element may be selected from the different data elements displayed by the web browser application. The web browser application may retrieve the different data elements from a data source, such as, a database, and may then display the different data elements to a user. The user may then select a first axis data element from the different data elements, displayed by the web browser application. An axis data element may be selected to render one of the axes of the visualization. In one embodiment, a pair of axes is an ordered pair of perpendicular lines which may be used to uniquely determine the position of a point or any other geometrical element in the visualization. The axis may be a row axis (X-axis) or a column axis (Y-axis). For example, the web browser application may display three data elements, “SALES”, “YEAR”, and “COUNTRY”, for selecting a row axis data element. The user may select the “SALES” data element as a row axis data element. The “SALES” data element may include data values “3000$”, “4000$”, and “5000$”. In another embodiment, the axis of the visualization may be a polar axis in a polar coordinate system.

Next at block 204, an axis type corresponding to the first axis data element selected at block 202 may be determined In one embodiment, the visualization generator may include different axis types and one of the axis types may be determined as the axis type of the selected first axis data element. Each axis type may represent an axis with particular characteristics. For example, the axis types may be a “quantitative axis” type or a “categorical axis” type. A “quantitative axis” type represents a numeric axis including quantitative data, which may include the minimum, maximum, and specific values represented by the numeric axis. The “quantitative axis” type may also include a metadata, for example, units, of the quantitative data. A “categorical axis” type represents a range of categories and values corresponding to each of the categories. The “categorical axis” type may include several sub-categories. For example, the “categorical axis” type may include a “nominal axis” type, an “ordinal axis” type, and an “interval axis” type. The “nominal axis” type represents a set of discrete categories, for example, products or countries. The “ordinal axis” type represents a categorical data that has an intrinsic order. For example, sizes (small, medium, and large), rankings (1^{st}, 2^{nd}, 3^{rd}), etc. The “interval axis” type may represent a quantitative range of values (0-100, 100-200, etc.). For example, time is an interval axis type, where each value (Years, Quarters, Months, etc.) represents an interval of time.

In one embodiment, the axis type of the first axis data element may be determined based on a data type of the first axis data element selected at block 202. A data type of a data element defines the type of data values of the data element. In one embodiment, the data type of a data element may be a dimension or a measure. A dimension is a line in a real or abstract space. An example of a real space dimension is a pair of antiparallel cardinal points on a compass, e.g., North and South, North-Northwest and South-Southeast. Another real dimension is time. An example of an abstract space dimension is a list of stores. Examples of dimensions include region, store, year, customer, employee, product line, and the like. A measure is a quantity as ascertained by comparison with a standard, usually denoted in some unit, e.g., units sold, dollars. In one embodiment, the axis type of the first axis data element may be determined as “quantitative axis” type when the data type of the first axis data element is a measure, and a “categorical axis” type when the data type of the first axis data element is a dimension. The web browser application may determine an axis type of the first axis data element based on the data type of the selected first axis data element. In the above example, the data type of the “SALES” data element may be a measure. Based on the data type, the axis type of the “sales” axis data element may be determined as a “quantitative axis” type. An axis includes a scale and a coordinate system. The coordinate system is Cartesian, polar, and the like. The scale includes a range—a set of values that define the scale, for example, minimum, maximum, and increment. The range comes from a domain fed to a mapping. These mappings are used for axes and for a data to visualization mappings to map data to any data point attribute.

Next at block 206, the first axis of the visualization may be rendered based on the axis type determined at block 204 and the data values of the first axis data element selected at block 202. The visualization generator may render the first axis of the visualization based on the determined axis type and the data values of the first axis data element. In one embodiment, the visualization generator may include a data-to-visualization mapping to determine a pixel position to place the rendered first axis on the visualization based on the data values of the first axis data element. The web browser application may then display the first axis at the determined pixel position of the visualization. Data-to-visualization mappings provide a mapping of a value in a data domain to a value in an output range, which may be, for example, pixel position, angles, color, or size of a particular component in the visualization. The input domain value may include, for example, a minimum and maximum data value when the data element is a measure, or discrete data values when the data element is a dimension. The data-to-visualization mapping may include interpolation functions, which may be used to translate input domain values to output range values. In one embodiment, the data-to-visualization mapping may include different scales for obtaining output range values corresponding to the input domain values. For categorical data the mapping may be an identity, an inverse (that is, change order), a grouping, or the like. For quantitative data the mapping may map continuous value to discrete values, be a transform selected from: multiplicative scaling, constant offset, linear, logarithm, power law, and the like. . The rendered first axis data element may then be displayed by the web browser application. In the above example, based on the determined axis type and data values of the “SALES” data element a quantitative axis may be rendered. The rendered quantitative axis may have five partitions each representing a range of 1000$.

Next at block 208-212 the steps of blocks 202-206 may be repeated for rendering a second axis of the visualization. In the above example, a “COUNTRY” axis data element, having data values “US”, “CANADA”, and “GERMANY”, may be selected as the “COUNTRY” axis data element. In this case, a second axis of “nominal axis” type may be rendered, which has three partitions to represent each of the three countries.

Next at block 214, a selection of a to-be-visualized data element may be received from the different data elements displayed by the web browser application. A to-be-visualized data element may be a data element, for which the visualization is to be rendered. In one embodiment, rendering the visualization may include rendering the data points corresponding to the data values of the to-be-visualized data element. The data points corresponding to the data values, of the to-be-visualized data element, may be rendered with respect to the first axis and the second axis rendered at blocks 206 and 212, respectively. In the above example, the user may select the “SALES” data element as the to-be-visualized data element.

Next at block 216, data point generation options may be displayed by the web browser application. The data point generation options may provide different options for generating the data points corresponding to the data values of the to-be-visualized data element. In one embodiment, the data point generation options may be provided with respect to the different data point generation parameters. Each of the data point generation parameters may allow a user to select or change a particular aspect of the data point. In one embodiment, the data point generation parameters may include a data point visualization type parameter and data point attributes related parameters. The data point visualization type options, corresponding to the data point visualization type parameter, may allow the user to select a visualization object for rendering the data points. For example, the data point visualization type options, corresponding to the visualization type parameter, may include a “dot” option, a “text” option, a “bar” option, a “line” option, a “tile” option, or any other visualization object. In case, a “dot” data point visualization type is selected then the data point corresponding to the data values, of the to-be-visualized data element, may be represented as dots in the visualization. Similarly, in case the “text” data point visualization type is selected then the data points corresponding to the data values, of the to-be-visualized data element, may be represented as texts in the visualization.

The data point generation options may also include data point attribute related options corresponding to different data point attribute parameters. The different data point attribute related options may be used to identify the data point visualization attributes based on which the visualization is to be rendered. The data point attributes related options may include, for example, a “size” attribute related option, a “color” attribute related option, or an “opacity” attribute related option, which may be used for changing the “size”, “color”, or the “opacity” of the data points. In one embodiment, “measure” data type data elements, retrieved by the web browser application, may be provided as data point attributes related options for some of the data point attribute parameters. In this case, the data point attribute values corresponding to the data point attribute parameter may be determined based on the data values of the selected measure type data element. The determined data point attribute values may then be used for rendering the visualization. In the above example, assume that the “SALES” data element is selected as a “size” attribute parameter. In this case, the size of the data points may vary depending on the data values “3000”, “4000”, and “5000” of the “SALES” data element. In one embodiment, the data-to-visualization mappings in the visualization generator may be used to determine the data point attribute values corresponding to the data values of the selected measure type data element. For example, a data-to-visualization mapping may be used to determine a percentage “opacity” value, corresponding to the data values of the data element selected as the data point “opacity” attribute option. The determined percentage opacity values may then be used to render data points with different opacity depending on the corresponding data values.

In another embodiment, the data point attribute related options may include different attribute values corresponding to the data point attribute parameters. For example, the data point attribute related options, for a “color” attribute parameter, may include a “RGB” color value, a “grey scale” color value, or a system determined color value. In one embodiment, different data point visualization types may be rendered differently depending on the selected data point attributes related options. For example, if the “size” data point attribute related option and the “dot” data point visualization type is selected, for rendering the data points, then the radius of the rendered “dot” data points may change depending on the data values of the selected measure type data element. However, if the “size” data point attribute option and the “bar” visualization type is selected, for rendering the data points, then the width of the rendered “bar” data points may change depending on the data values of the selected data element.

Next at block 218, a selection of a data point generation option may be received from the data point generation options displayed at block 216. The data point generation option may be used by the render to render the data points corresponding to the data values of the to-be-visualized data elements. In one embodiment, a data point visualization type may be selected from the data point visualization options for rendering the data points in the visualization. Data point attribute options may also be selected, with respect to some of the data point attribute parameters, to render the visualization. In one embodiment, a default data point option, for example, a “dot” visualization type, may be selected by the visualization generator to render the visualization. The data point generation option, for rendering the data points, may also include data values of the to-be-visualized data point and data point coordinates for positioning the data points on the visualization. The data-to-visualization mapping may determine the data point coordinates for placing the data points on the visualization, based on the data values of the to-be-visualized data element. In the above example, a “bar” data point visualization type and a “RGB” data point color attribute may be selected for rendering the data points corresponding to the “SALES” data element.

Next at block 220, different data point relative visualization options may be presented by the web browser application. The different data point relative visualization options may provide different options for positioning and viewing data points with respect to each other. In one embodiment, the data point relative visualization options may include a comparison mode, a part-to-whole model, and a distribution mode. In a comparison mode the data points may be visualized independent of each other. In a part-to-whole mode, the data point corresponding to a data value may represent the proportion contribution of the data value with respect to a sum of to-be-visualized data element's values. For example, if a “part-to-whole” mode and a “dot” visualization type are selected, for rendering data points of the visualization, then a pie chart may be rendered. Each region of the pie chart may correspond to a data value of the to-be-visualized data element and may represent the contribution of the data value with respect to the sum of the data values. Similarly a stacked bar chart may be rendered if the part-to-whole” mode and a “bar” visualization type is selected.

In a distribution mode a set of summary values of the data points may be visualized, the set of summary values may represent the shape of the data values, for example—minimum, maximum, and mean of the data values included in the to-be-visualized data element. For example, a box plot is a distribution mode visualization, where the group of numerical data are represented by five-number summary values: the smallest observation (sample minimum), lower quartile (Q1), median (Q2), upper quartile (Q3), and largest observation (sample maximum). A box plot may also indicate which observations, if any, might be considered outliers.

Next at block 222, a selection of a data point relative visualization option may be received from the data point relative visualization options displayed at block 220. The data point relative visualization option may be selected for viewing the data points, of the to-be-visualized data element, with respect to each other. In one embodiment, a data point generation option may be determined based on the selected data point relative visualization option. For example, data point coordinates, to position the data point on the visualization, may be determined based on the selected data point visualization option. In case the “comparison mode” is selected then the data point coordinates may be determined corresponding to the data values of the to-be-determined data element.

In case a part-to-whole relative visualization option is selected then a cumulative total of the data values corresponding to the to-be-determined data element may be calculated. The determined cumulative data values may then be used for determining the data point coordinates for placing the data points on the visualization. In the above example, assume that a “part-to-whole” relative visualization mode is selected for visualizing the data elements 3000$, 4000$, and 5000$ of the “SALES” data element. In this case, a cumulative total 7000 of the first two values, 3000 and 4000, may be calculated to determine the data point coordinates for positioning a “bar” data point corresponding to the second data value 4000. Further, a cumulative total 12000 of the data values, 3000, 4000, and 5000, may be calculated to determine the data point coordinates for positioning a “bar” data point corresponding to the third data value 5000. The renderer may offset the starting position of the “bar” data points depending on the “bar” data point position of a previous data value. For example, a first “bar” data point representing a data value 3000 may be rendered for the first data value 3000. The data point coordinates for positioning a second “bar” data point corresponding to the second data value 4000 may be offset with respect to the data point coordinates of the first “bar” data point. In this case, the second “bar” data point may start from the data point coordinates position of the first bar and extend to a data point position representing the cumulative data value 7000 of the first and the second data values. Similarly, the third “bar” data point may start from the data point position of the second bar data point and extend to a data point position representing the cumulative total 12000 of the first, second, and third data values. The three “bar” data points may together form a stacked bar representing the three data values of the “SALES” data element.

Next at block 224, the visualization may be rendered based on the data point generation option selected at block 218 and the data point relative visualization option selected at block 222. In one embodiment, generating the visualization may include rendering the data points corresponding to the data values of the to-be-visualized data element and positioning the rendered data points on the visualization. The data points may be positioned with respect to the first axis and the second axis rendered at blocks 206 and 212, respectively. The data points may be rendered based on the data point generation options selected at block 218 and the data point generation options determined based on the selected data point relative visualization option at block 222. In one embodiment, the visualization generator may render the visualization based on the data point generation options. The rendered visualization may be displayed by the web browser application. In one embodiment, the visualization generator may render the visualization as a Scalable Vector Graphics (SVG) file, which may be displayed by the web browser. In the above example, a stacked bar, with three portions colored in “RED”, “GREEN”, or “BLUE” color may be rendered by the visualization generator. The rendered stack bar may be displayed by the web browser application.

In one embodiment, the visualization generator may render the visualization incrementally. Incremental visualization creation may include generating and displaying of the visualization after each data point generation option selection or data point relative visualization option selection without changing the other aspects of the visualization. For example, in case a user selects a data element and a data point visualization type parameter as “dot” then several “dot” data points representing the data values of the data element may be rendered. Next, if the user selects the data element as a data point attribute option for a “size” data point attribute parameter then the size of the rendered dots, in the visualization, may be changed in depending on the data values of the data element without changing the earlier selected visualization type “dot” of the visualization. Further, if the user changes the visualization type from a “dot” to a “bar” then the “dot” data points in the rendered visualization may be changed to “bar” data points. In this case, the width of the “bar” data points may represent the data values, due to the earlier selected “size” attribute. Incremental visualization may allow the user to visualize the effect of their selection after each selection of data point generation option selection or data point relative visualization option selection. This may help the user perform an informed decision to modify the displayed visualization or to render a new visualization.

In one embodiment, the user may select a data point generation option or a data point relative visualization option for modifying the visualization rendered at block 224 (block 226). Finally at block 228, the visualization rendered at block 224 may be re-rendered depending on the selections received at block 226. The re-rendered visualization may then be displayed by the web browser application. In the above example, a user may select a data point visualization type as “dot” data point to modify the rendered “bar” data points corresponding to the “SALES” data element. In this case, “dot” data points may be re-rendered for the data values corresponding to the “sales” data element. The rendered “dot” data points may then be displayed by the web browser application. In one embodiment, each drawn object in the visualization SVG file may be represented as an SVG object. The renderer may modify the attributes of the different SVG objects, in the visualization, based on the options selected at block 226. The modified visualization (modified SVG file) may then be displayed to the user by the web browser application.

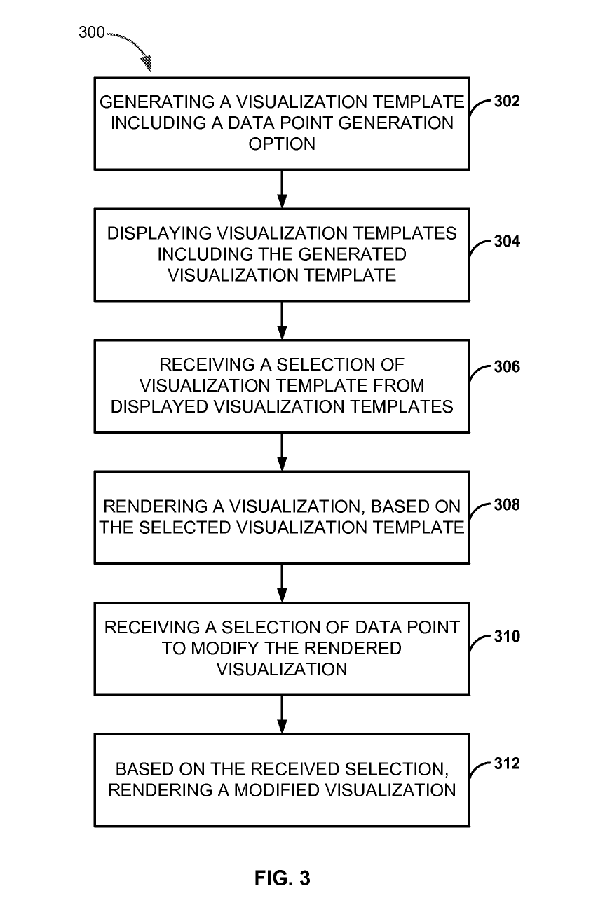

FIG. 3 is a flow diagram 300 illustrating a method to render a visualization based on visualization template, according to an embodiment. In some embodiments, the visualization template supports incremental creation of a visualization. Incremental visualization creation allows a user to alter one aspect of a visualization, such as, a mark type or an axis, and not alter other aspects. In one embodiment, a visualization template may be generated based on the data point generation options included in the visualization generator (block 302). A user may select the data point generation options, from the different visualization options included in the visualization template, to generate the visualization template. The generated visualization template may then be stored in the visualization generator. A visualization template may include a pre-selection of different data point generation options, which may be used to render the visualization. The visualization may be rendered based on the pre-selected data point generation options included in the visualization template. For example, a dot visualization template may be generated by selecting a “dot” data point visualization type and an “RGB” color attribute. In this case, “dot” data points, which may be colored based on the RGB color scheme, may be rendered corresponding to the data values of a to-be-visualized data element, in case the dot visualization template is selected.

In one embodiment, the visualization generator may store several pre-defined visualization template. The pre-defined visualization templates may include a bar chart visualization template, a scatter plot visualization template, etc. Next at block 304, the different data point visualization templates stored in the visualization generator may be displayed at the web browser application. A user may then select a visualization template from the displayed visualization templates to render visualization (block 306). The visualization generator may then render the visualization based on the selected visualization template (block 308). The visualization may be rendered for a to-be-visualized data element. In one embodiment, the selected visualization template may bound to the data values of the to-be-visualized data element at run time, to render the visualization. The rendered visualization may then be displayed by the web browser application.

In one embodiment, a selection of data point generation option or a data point relative visualization option may be received to modify the visualization rendered at block 308 (block 310). The modification option may be received to modify the visualization rendered, at block 308, based on a visualization template. Next at block 312, a modified visualization may be re-rendered based on the selection received at block 310. In the above example, a user may select a “bar” data point visualization type to modify the visualization rendered based on the “dot” visualization template. Based on the received selection, the “dot” data points in the visualization may be changed to “bar” data points.

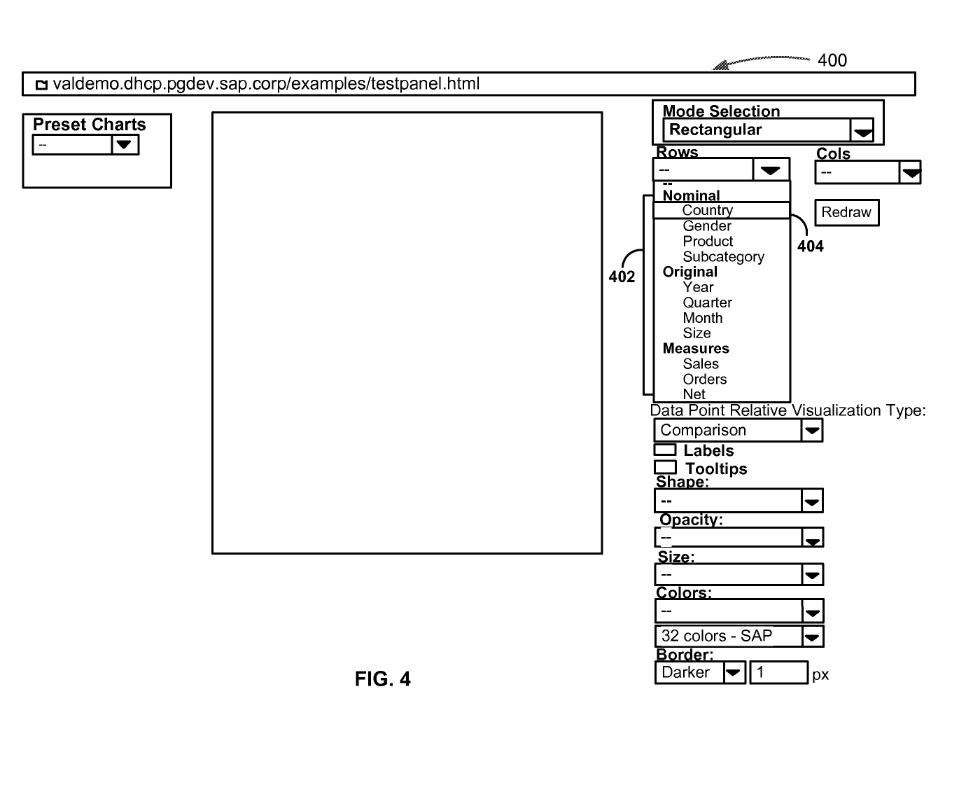

FIG. 4 is an exemplary block diagram illustrating a web browser application 400 displaying different data elements for selecting a row axis data element, according to an embodiment. In one embodiment, the web browser application 400 may retrieve data elements 402 from a data source and may then display the data elements 402 to a user. The user may then select a row axis data element from the displayed data elements 402. As shown, a user selects a “Country” data element 404, from the displayed data elements 402, as the row axis data element. The data type and the data value of the “Country” data element 404 may be used to render a row axis. The country data elements may include data values “Canada”, “England”, “France”, and “Germany”.

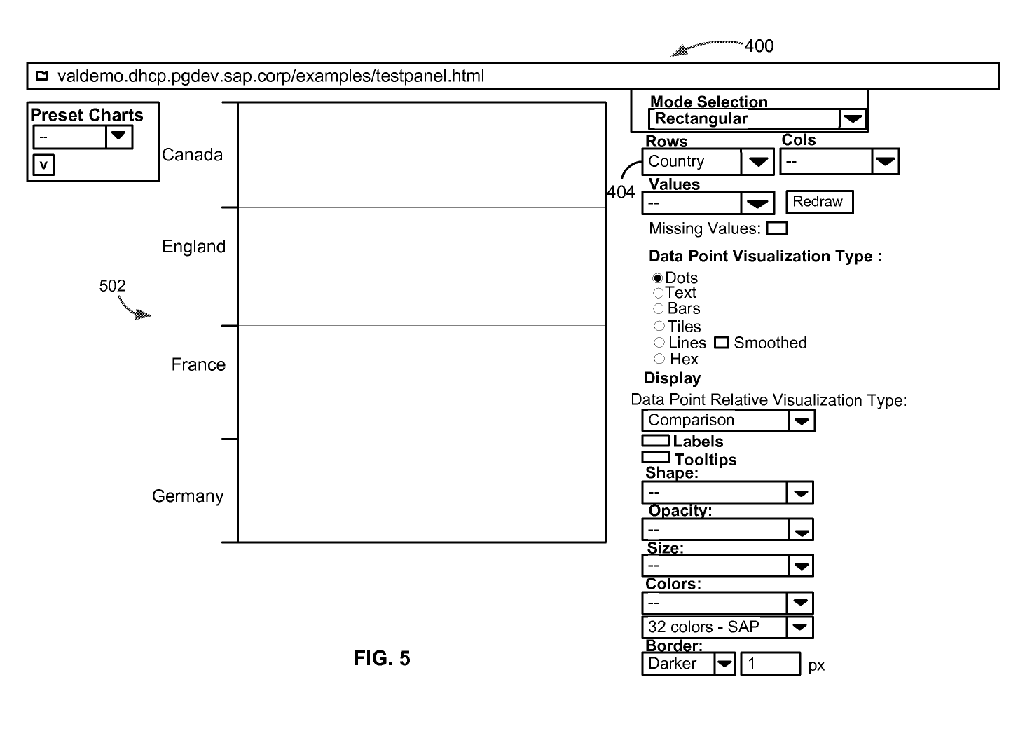

FIG. 5 is an exemplary block diagram illustrating the web browser application 400 of FIG. 4 displaying a rendered row axis 502, according to an embodiment. Based on the data type and the data values of the selected “Country” axis data element 404, a nominal row axis 502 that includes the data values “Canada”, “England”, “France”, and “Germany” of the selected “Country” axis data element 404 may be rendered. In one embodiment, the web browser application 400 may forward the data type “nominal” and the data values “Canada”, “England”, “France” and “Germany” of the selected “Country” axis data element 404 to a visualization generator, which may then render the “nominal” row axis 502. The rendered nominal row axis 502 may then be displayed by the web browser application 400.

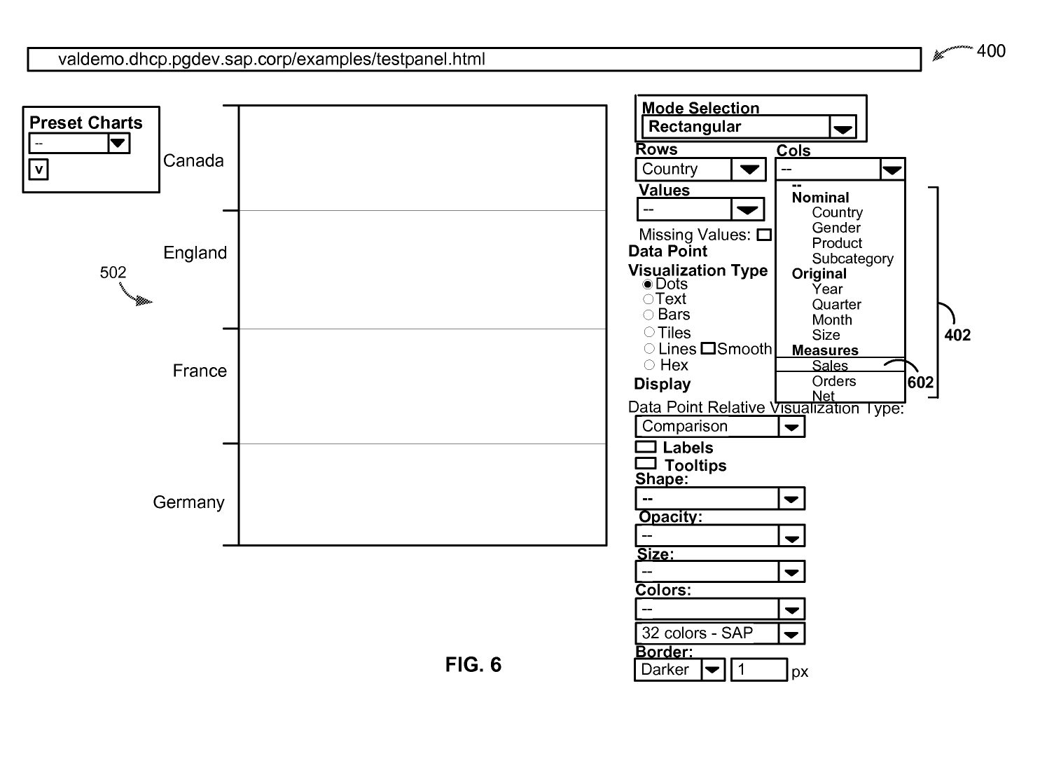

FIG. 6 is a block diagram illustrating the web browser application 400 of FIG. 4 displaying different data elements 402 for selecting a column axis data element, according to an embodiment. The column axis data element may be selected to render a column axis. As shown, a user selects a “Sales” data element 602, from the displayed data elements 402, as the column axis data element. The “Sales” column axis data element may include data values 95, 25, 35, and 85 corresponding to the sales in “Canada”, “England”, “France”, and “Germany”, respectively.

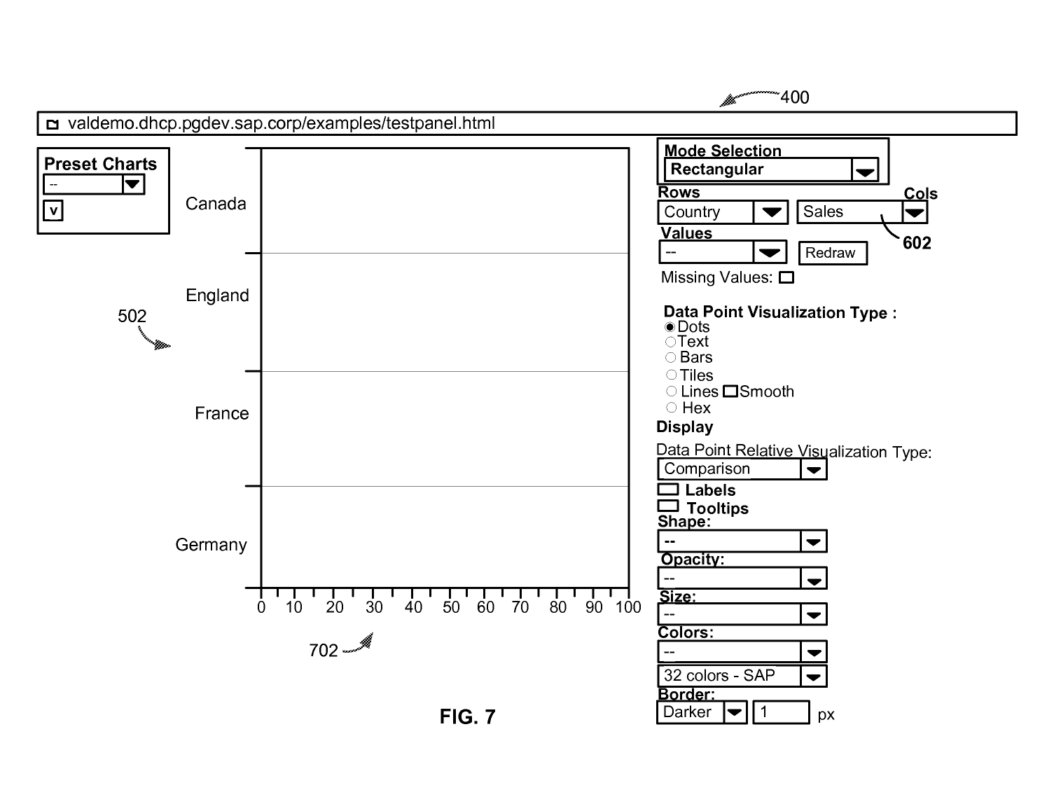

FIG. 7 is an exemplary block diagram illustrating the web browser application 400 of FIG. 4 displaying a rendered column axis 702, according to an embodiment. The column axis 702 may be rendered based on the data type and the data values of the selected “SALES” data element 404. In one embodiment, the web browser application 400 may forward the data type “measure” and the data values 95, 25, 35, and 85, of the “SALES” data element 404, to a visualization generator. The visualization generator may then render a “quantitative” column axis 702 based on the data type “measure” of the “sales” data element. The “quantitative” column axis 702 may include 100 units to include the minimum data value (25) and the maximum data value (95) of the “Sales” data element. The rendered “measure” column axis 702 of the visualization 406 may be displayed by the web browser application.

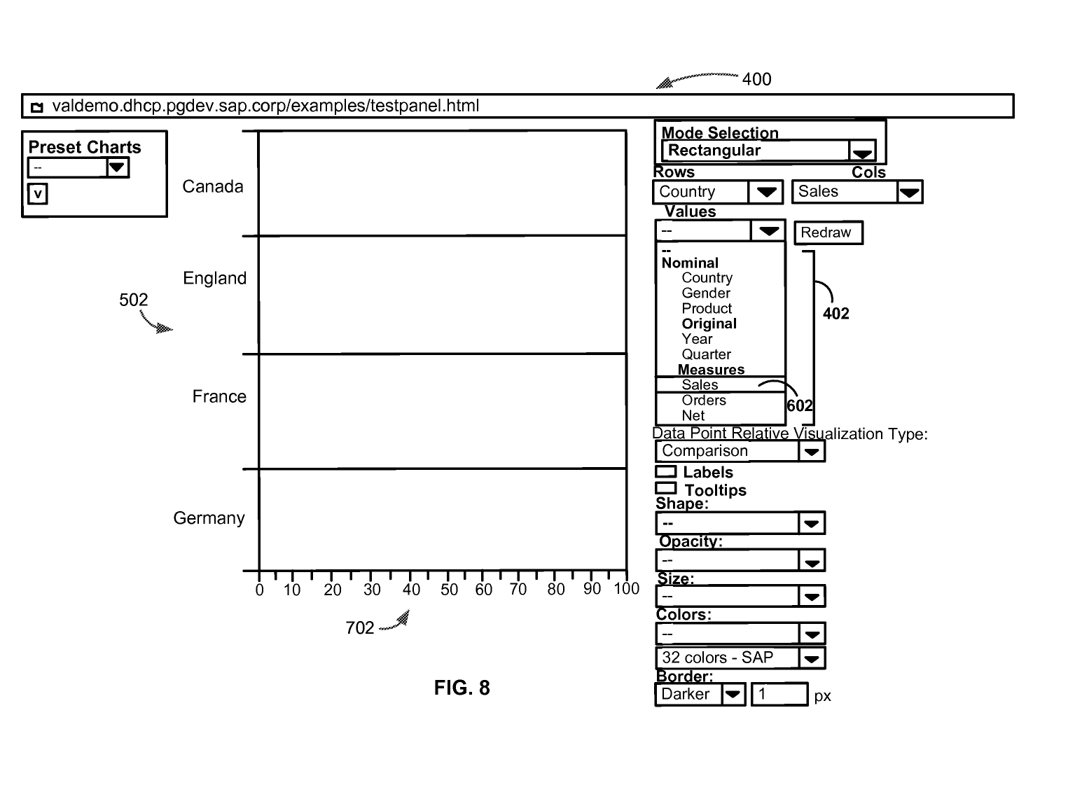

FIG. 8 is a block diagram illustrating the web browser application 400 of FIG. 4 displaying different data elements 402 for selecting a to-be-visualized data element, according to an embodiment. The “to-be-visualized” data element is a data element, for which the visualization is to be rendered. In one embodiment, data points may be displayed in the visualization corresponding to the data values of the to-be-visualization data element. As shown the “Sales” data element 602 is selected as the to-be-visualized data element.

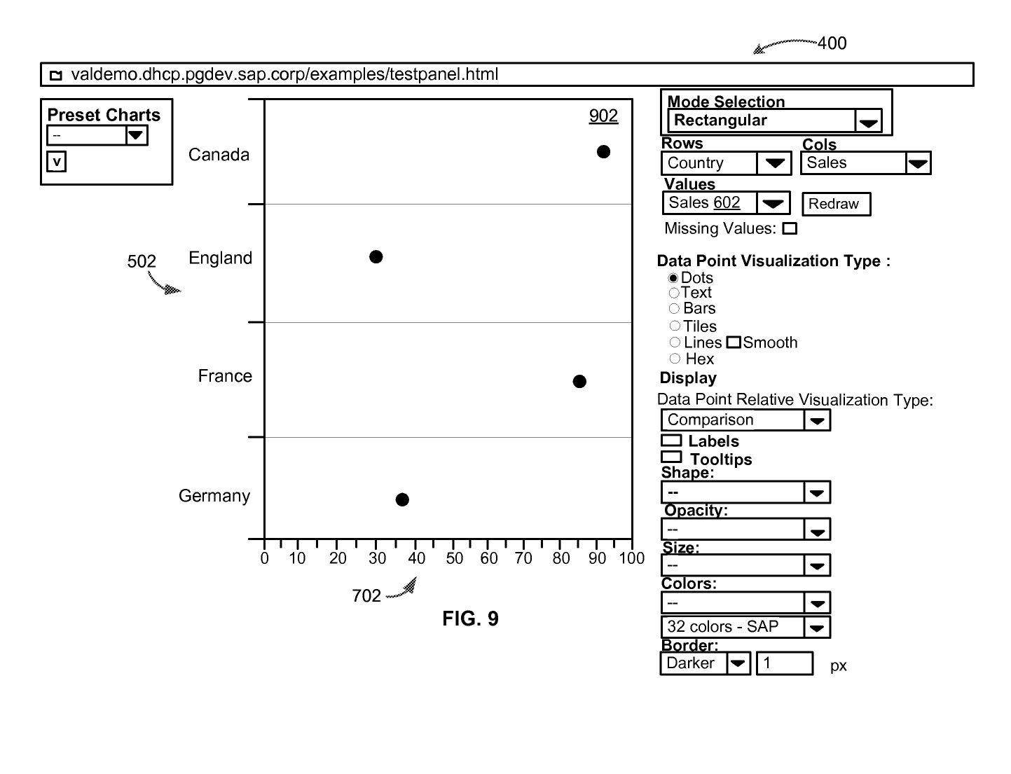

FIG. 9 is a block diagram illustrating the web browser application 400 of FIG. 4 displaying a visualization corresponding to the data values of the selected to-be-visualized data element, according to an embodiment. The visualization may include data point corresponding to the data values of the to-be-visualized “Sales” data element 602. In one embodiment, the web browser application 400 may display data point generation options and data point relative visualization option to a user. The data point generation options are provided corresponding to different data point generation parameters, such as, “a visualization type” data point generation parameter, a “shape” data point generation parameter, a “size” data point generation parameter, a “color” data point generation parameter. The visualization may be generated based on the data point generation options and the data point relative visualization option selected by the user. As shown, the user selects a “dot” as the data point visualization type from the displayed data point generation options. Based on the selected data point visualization type, four dots representing the four data values of the to-be-visualized “Sales” data element 602 may be rendered. The four data points may be positioned on the visualization 902 with respect to the rendered “Sales” column axis 702 and the “Country” row axis 502.

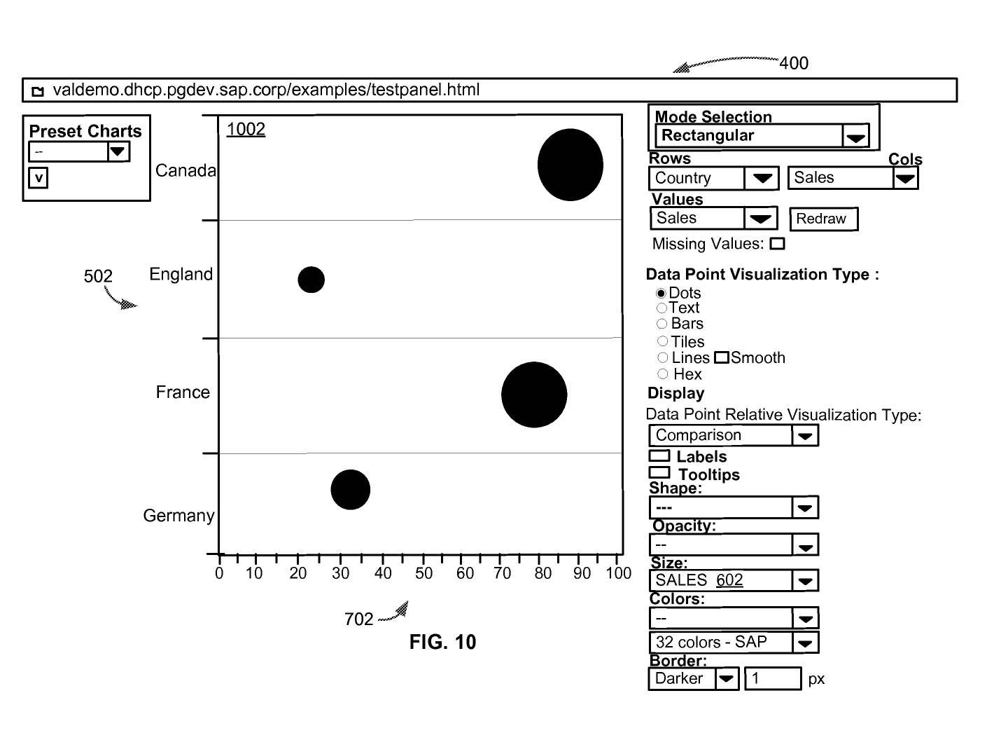

FIG. 10 is a block diagram illustrating the web browser application 400 of FIG. 4 displaying a re-rendered visualization 1002 based on a selected data point generation option, according to an embodiment. The visualization 902 of FIG. 9 may be re-rendered to generate the visualization 1002. In one embodiment, the visualization 902 of FIG. 9 is re-rendered after a user selects the “Sales” data element 602 as a data point generation option for the “size” data point attribute parameter. The visualization 1002 may be obtained by changing the size of the data points in the visualization 902 of FIG. 9 based on the data values of the selected “Sales” data element 602. A user may want to incrementally change visualization 1002. For example, by specifying a new scale for axis 702. Examples of a new scale could include changing the minimum, the mapping or the like. Examples of mapping changes include moving to a log base 2 scale. The re-rendering of visualization 1002 (not shown) would have an axis running from zero to two, with data points redistributed horizontally from about four to about 6.5. The vertical axis and the position of the data points remain constant. Another example incremental change is the addition of a reference mark. The user can add to visualization a mark that is not a data point but may be derived from the data. For example, an average could be added in the form of a vertical line intersecting the horizontal axis. Some embodiments include reference marks for calculated values, annotations, key dates, and the like. The mark can be a dot, line, bar, tile, and the like.

Some embodiments may include the above-described methods being written as one or more software components. These components, and the functionality associated with each, may be used by a client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls or web services being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. Some embodiments include an application, such as, a web browser application, linked to a library via an application programming interface. The library include computer executable instruction to provide mappings, render visualizations or partially render visualizations, providing visualizations for displaying by the web browser application, and the like. Some embodiments include instruction executed by the library to effect at least one of, receiving a selection of a to-be-visualized data element, providing a plurality of data point generation options corresponding to a plurality of data point generation parameters, receiving a selection of one or more data point generation options from the provided plurality of data point generation options for rendering of the plurality of data values, rendering the visualization including the plurality of data points, and providing the visualization. Further embodiments include, executing a visualization generator storing the data point generation options, for rendering the visualization including the plurality of data points. Still further embodiments include, at least one of, receiving a selection of axes data elements from the plurality of data elements, determining an axis type, rendering an axis of the axes, and providing the axis. Additional embodiments include instructions for, providing a plurality of data point visualization type options, and providing a plurality of data point attribute options. Other embodiments include instructions for, doing at least one of, determining (based on a data-to-visualization mapping relationship) a plurality of data point attribute values corresponding to the plurality of data values, rendering a visualization including the plurality of data points, and providing the visualization. Some embodiments include instructions for providing a plurality of data point relative visualization options to visualize the data points in relation to each other, receiving a selection of a data point relative visualization option from a provided plurality of data point relative visualization options, and based on a selected data point relative visualization option, determining a data point generation option to render. Some embodiments include instructions for generating a visualization template. Additional embodiments include instruction for, receiving a selection of data point option to modify a visualization, rendering a modified visualization, and provide the visualization to the application. The application may be running in a client. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

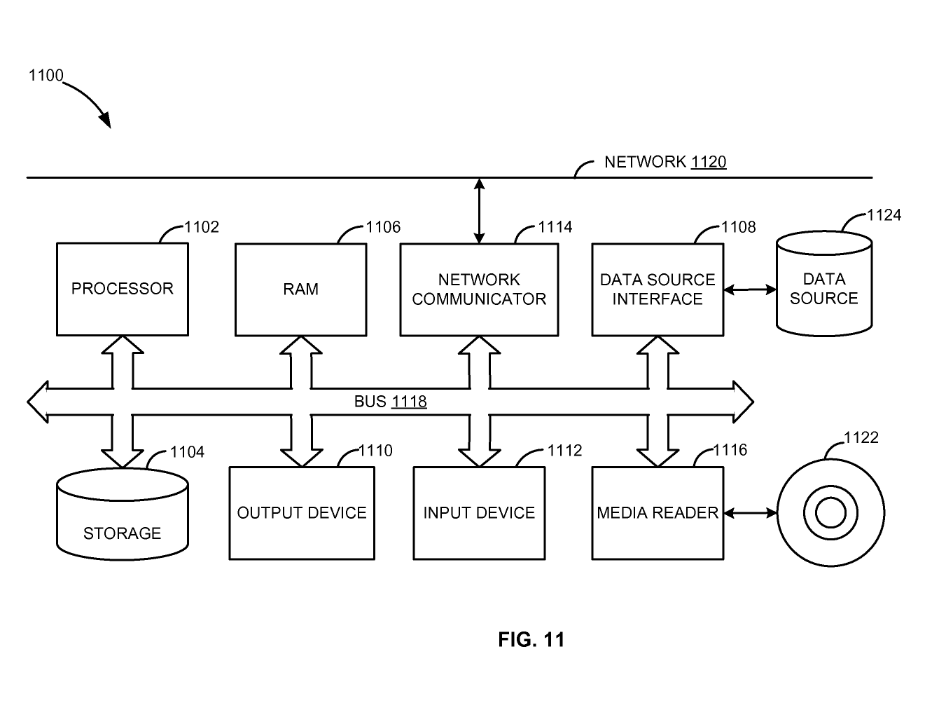

FIG. 11 is a block diagram of an exemplary computer system 1100. The computer system 1100 includes a processor 1102 that executes software instructions or code stored on a computer readable storage medium 1122 to perform the above-illustrated methods. The processor 1102 can include a plurality of cores. The computer system 1100 includes a media reader 1116 to read the instructions from the computer readable storage medium 1122 and store the instructions in storage 1104 or in random access memory (RAM) 1106. The storage 1104 provides a large space for keeping static data where at least some instructions could be stored for later execution. According to some embodiments, such as some in-memory computing system embodiments, the RAM 1106 can have sufficient storage capacity to store much of the data required for processing in the RAM 1106 instead of in the storage 1104. In some embodiments, all of the data required for processing may be stored in the RAM 1106. The stored instructions may be further compiled to generate other representations of the instructions and dynamically stored in the RAM 1106. The processor 1102 reads instructions from the RAM 1115 and performs actions as instructed. According to one embodiment, the computer system 1100 further includes an output device 1110 (e.g., a display) to provide at least some of the results of the execution as output including, but not limited to, visual information to users and an input device 1112 to provide a user or another device with means for entering data and/or otherwise interact with the computer system 1100. Each of these output devices 1110 and input devices 1112 could be joined by one or more additional peripherals to further expand the capabilities of the computer system 1100. A network communicator 1114 may be provided to connect the computer system 1100 to a network 1120 and in turn to other devices connected to the network 1120 including other clients, servers, data stores, and interfaces, for instance. The modules of the computer system 1100 are interconnected via a bus 1118. Computer system 1100 includes a data source interface 1108 to access data source 1124. The data source 1124 can be accessed via one or more abstraction layers implemented in hardware or software. For example, the data source 1124 may be accessed by network 1120. In some embodiments the data source 1124 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments are described herein for illustrative purposes, various equivalent modifications are possible, as those skilled in the relevant art will recognize. These modifications can be made in light of the above detailed description. Rather, the scope is to be determined by the following claims, which are to be interpreted in accordance with established doctrines of claim construction.

1. A computer implemented method for rendering a visualization, the method comprising:
at a user interface of the computer, receiving a selection of a to-be-visualized data element, including a plurality of data values, from a plurality of data elements retrieved from a memory of the computer;
at the user interface of the computer, displaying a plurality of data point generation options, corresponding to a plurality of data point generation parameters, to visualize the to-be-visualized data element;
at the user interface of the computer, receiving a selection of one or more data point generation options from the displayed plurality of data point generation options, to render a plurality of data points representing the plurality of data values; and
based on the selected one or more data point generation options, rendering by the processor of the computer, the visualization including the plurality of data points.

2. The computer implemented method according to claim 1, wherein rendering the visualization includes:
executing, by the processor of the computer, a visualization generator storing the plurality of data point generation options, to render the visualization including the plurality of data points.

3. The computer implemented method according to claim 2, further comprising:
at the user interface of the computer, receiving a selection of axes data elements from the plurality of data elements;
based on a data type of the axes data elements, determining by the processor of the computer an axis type from a plurality of axis types included in the visualization generator corresponding to the selected axes data elements; and
based on the determined axis type and data values of the axes data elements, executing by the processor of the computer the visualization generator to render an axes of the visualization.

4. The computer implemented method according to claim 1, wherein displaying the plurality of data point generation options includes:
at the user interface of the computer, displaying a plurality of data point visualization type options and a plurality of data point attribute options corresponding to the plurality of data point generation parameters.

5. The computer implemented method according to claim 4, further comprising:
based on a data-to-visualization mapping relationship, determining by the processor of the computer a plurality of data point attribute values corresponding to the plurality of data values; and
based on the determined plurality of data point attribute values, rendering by the processor of the computer the visualization including the plurality of data points.

6. The computer implemented method according to claim 1, further comprising:
at the user interface of the computer, displaying a plurality of data point relative visualization options to visualize the data points in relation to each other;
at the user interface of the computer, receiving a selection of a data point relative visualization option from the displayed plurality of data point relative visualization options; and
based on the selected data point relative visualization option, determining a data point generation option to render the plurality of data points representing the plurality of data values.

7. The computer implemented method according to claim 1, further comprising:
generating, by the processor of the computer, a visualization template based on a selected data point generation option from the plurality of data point generation options.

8. The computer implemented method according to claim 7, further comprising:
at the user interface of the computer, receiving a selection of the visualization template to visualize the to-be-visualized data element; and
based on the selected visualization template, rendering by the processor of the computer the visualization including the plurality of data points representing the plurality of data values.

9. The computer implemented method according to claim 1, further comprising:
at the user interface of the computer, receiving by the processor of the computer a selection of data point option from the plurality of data point options to modify the rendered visualization; and
based on the received selection, executing by the processor of the computer the visualization generator to render a modified visualization.

10. A computer system for rendering a visualization, the computer system comprising:
a memory to store a program code; and
a processor communicatively coupled to the memory, the processor configured to execute the program code to:
receive a selection of a to-be-visualized data element, including a plurality of data values, from a plurality of data elements;
display a plurality of data point generation options, corresponding to a plurality of data point generation parameters, to visualize the to-be-visualized data element;
receive a selection of one or more data point generation options, from the displayed plurality of data point generation options, to render a plurality of data points representing the plurality of data values; and
based on the selected one or more data point generation options, render a visualization generator, storing the plurality of data point generation options, to render the visualization including the plurality of data points.

11. The system according to claim 10, wherein the processor further executes the program code to:
execute, a visualization generator, storing the plurality of data point generation options, to render the visualization including the plurality of data points.

12. The system according to claim 11, wherein the processor further executes the program code to:
receive a selection of axes data elements from the plurality of data elements;
based on a data type of the axes data elements, determine an axis type, from a plurality of axis types included in the visualization generator, corresponding to the selected axes data elements; and
based on the determined axis type and data values of the axes data elements, execute the visualization generator to render an axes of the visualization.

13. The system according to claim 10, wherein the processor further executes the program code to:
display a plurality of data point visualization type options and a plurality of data point attribute options, corresponding to the plurality of data point generation parameters.

14. The system according to claim 13, wherein the processor further executes the program code to:
based on a data-to-visualization mapping relationship, determine a plurality of data point attribute values corresponding to the plurality of data values; and
based on the determined plurality of data point attribute values, render the visualization including the plurality of data points.

15. The system according to claim 14, wherein the processor further executes the program code to:
display a plurality of data point relative visualization options to visualize the data points in relation to each other;
receive a selection of a data point relative visualization option from the displayed plurality of data point relative visualization options; and
based on the selected data point relative visualization option, determining a data point generation option to render the plurality of data points representing the plurality of data values.

16. An article of manufacture including a non-transitory computer readable storage medium to tangibly store instructions, which when executed by a computer, cause the computer to:
receive a selection of a to-be-visualized data element, including a plurality of data values, from a plurality of data elements;
display a plurality of data point generation options, corresponding to a plurality of data point generation parameters, to visualize the to-be-visualized data element;
receive a selection of one or more data point generation options, from the displayed plurality of data point generation options, to render a plurality of data points representing the plurality of data values; and
based on the selected one or more data point generation options, render a visualization including the plurality of data points.

17. The article of manufacture of claim 16, further comprising instructions which when executed by the computer further causes the computer to:
execute a visualization generator, storing the plurality of data point generation options, to render the visualization including the plurality of data points.

18. The article of manufacture of claim 17, further comprising instructions which when executed by the computer further causes the computer to:
receive a selection of axes data elements from the plurality of data elements;
based on a data type of the axes data elements, determine an axis type, from a plurality of axis types included in the visualization generator, corresponding to the selected axes data elements; and
based on the determined axis type and data values of the axes data elements, execute the visualization generator to render an axes of the visualization.

19. The article of manufacture of claim 16, further comprising instructions which when executed by the computer further causes the computer to:
display a plurality of data point visualization type options and a plurality of data point attribute options, corresponding to the plurality of data point generation parameters.

20. The article of manufacture of claim 19, further comprising instructions which when executed by the computer further causes the computer to:
based on a data-to-visualization mapping relationship, determine a plurality of data point attribute values corresponding to the plurality of data values; and
based on the determined plurality of data point attribute values, render the visualization including the plurality of data points.
